(19) United States
(12) Patent Application Publication
(10) Pub. No.: US 2007/0012200 A1
(43) Pub. Date: Jan. 18, 2007

(54) Structural ring system for kaiten (conveyor belt) sushi restaurants

(76) Inventors: James C. Allard, Seattle, WA (US); Steve Rosen, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/485,843

(22) Filed: Jul. 12, 2006

Related U.S. Application Data
(60) Provisional application No. 60/699,815, filed on Jul. 15, 2005.

(51) Int. Cl. A47J 43/18

(52) U.S. Cl. 99/426

(57) ABSTRACT

A structural ring to support a plate traveling on a conveyor belt system. The conveyor belt system has a movable belt portion disposed between two lateral guide surfaces. The structural ring has a first end that rests on the movable belt of the conveyor belt system, and a second end that supports the plate. The ring is sized to be disposed between lateral guide surfaces of the conveyor belt system so that the bottom surface of a plate supported by the second end of the structural ring is located above the lateral guide surfaces. A cross-member at least partially occupies the first end of the ring and operably couple the structural ring to the movable belt.

### CROSS-REFERENCE TO RELATED APPLICATION

This application claims the benefit under 35 U.S.C. § 119 of U.S. Provisional Patent Application No. 60/699,815, filed Jul. 15, 2005, the disclosure of which is hereby expressly incorporated by reference.

### TECHNICAL FIELD

The presently claimed subject matter relates generally to a conveyor belt system and, more specifically, to a conveyor belt system for delivering food items in a restaurant setting.

### BACKGROUND

In a “kaiten” sushi restaurant, a conveyor belt transports plates containing food items through the restaurant and past customers, allowing customers to serve themselves to the food items that they choose by simply removing a plate containing the desired food item from the conveyor belt. The conveyor belt is an endless belt that travels around the restaurant, at some point closing back onto itself, thereby creating a closed circuit. Sushi chefs typically stand inside the closed circuit formed by the belt and prepare assorted sushi and related food items. The food items are put on small color coded plates that are subsequently placed on the conveyor belt. The color of a plates relates to the price of the food item on that plate. For example, a food item on a green plate may be one price, a food item on a yellow plate may be another price, a third food item on a light blue plate may be yet another price, and so on.

Once placed on the conveyor belt, the plates travel around the circuit formed by the conveyor belt, putting the various food items within reach of the restaurant customers. As the plates travel past customers, the customers select food items by taking plates containing the selected food items from the conveyor belt. Removing a plate from the conveyor belt leaves an empty place on the conveyor belt. The sushi chefs work to quickly fill the empty places left by the removed plates with plates containing freshly prepared food items. As a customer finishes the food items contained on individual plates, the customer simply stacks the empty plates on the table. At the end of a meal, a server calculates the customer's bill based on the number of each color of plate in the customer's stack of plates.

Although the conveyor belt systems used in kaiten sushi restaurants are an effective way to serve customers, they offer several distinct disadvantages. One disadvantage is that the customer often has difficulty removing a plate from the conveyor belt due to difficulty grasping the plate. The movable belt upon which the plates travel generally rides between two lateral guide surfaces that guide the movable belt on its path through the restaurant. The lateral guide surfaces provide structural support to the conveyor belt and also hide the machine workings of the conveyor belt itself from the customer. Further, the conveyor belt is designed so that the movable belt is located below the upper edge of lateral guide surfaces to prevent plates from sliding off of the belt. Absent lateral guide surfaces, plates may slide off the movable belt as it rounds a corner. Also, if plates are placed on the movable belt too close together, they may contact each other as they travel around corners. Without a slightly recessed conveyor belt, even gentle pressure from a plate behind can be sufficient to push the forward plate off of the conveyor belt. Due to the limited height of a typical sushi plate, and given that the conveyor belt itself is often recessed, customers frequently have difficulty grasping the plate as it passes by because the visible plate edge is often too slight allow the customer to comfortably grasp a plate with confidence.

A further disadvantage with kaiten sushi restaurants is that some customers have difficulty identifying what is on each plate on the conveyor belt. Customers may be unfamiliar with sushi and, as a result, are unable to identify food items as they travel by on the conveyor belts. Customers unable to determine the name of a food item, the ingredients of that food item, or how that food item is prepared may be reluctant to try that food item. Further, customers unfamiliar with the various food items may direct their questions about the food items to restaurant workers, detracting from the restaurant workers ability to perform their primary duties.

Another disadvantage that frequently arises in current kaiten sushi restaurants is that sushi chefs have difficulty managing the variety of food items present on the conveyor belt. Making a wide variety of food items readily available to the customers is critical to customer satisfaction. Keeping the conveyor belt well stocked with a full menu also serves customers more quickly, thereby increasing the overall number of customers that the restaurant can serve in a given period of time. In a typical kaiten sushi environment, customers have limited ability to control what the chefs produce, and sushi chefs are often too busy to effectively scan the belt in order to visually see what items need to be produced. As a result, during busy times, sushi chefs often resort to making what they know they can produce quickly. When this occurs, the variety of available food choices suffers, as does customer satisfaction.

### SUMMARY

The following summary is provided to introduce a selection of concepts in a simplified form that are further described below in the Detailed Description. This summary is not intended to identify key features of the claimed subject matter, nor is it intended to be used as an aid in determining the scope of the claimed subject matter.

A structural ring is provided to be used with a plate and a conveyor belt system. The conveyor belt system has a movable belt portion located between two lateral guide surfaces. A first end of the structural ring rests on the movable belt and a second end supports the plate. The structural ring has a cross-section generally sized to be fit between the lateral guide surfaces of the conveyor belt system. A cross-member at is located generally at the first end of the structural ring and couples the structural ring to the movable belt. When the plate is placed on the second end of the structural ring, the bottom surface of the plate is located above the lateral guide surfaces of the conveyor belt system.

In one embodiment, a food delivery system uses a conveyor belt system with the previously described structural rings to deliver plates containing food items from a location where the food items are prepared to a second location where a person can remove the plates from the conveyor belt system. Food is prepared at the first location and placed on the plates. Each plate is then placed on structural ring, which is resting between the lateral guide surfaces on the movable belt portion of the conveyor belt system. The structural rings support the plates so that the bottom surfaces of the plates are located above the lateral guide surfaces. The conveyor belt system transports the plates, each of which is supported by a structural ring, to a second location where a person can remove a plate from the conveyor belt system.

### DESCRIPTION OF THE DRAWINGS

The foregoing aspects and many of the attendant advantages of the presently-claimed subject matter will become better understood by reference to the following detailed description when taken in conjunction with the accompanying drawings, wherein:

FIG. 1 is an isometric view showing customers sitting in a kaiten sushi restaurant as food items travel by on a conveyor belt system;

FIG. 2 is a cross-sectional view of the conveyor belt system of a typical kaiten sushi restaurant as a customer tries to remove a plate from the conveyor belt;

FIG. 3 is an isometric view of a structural ring constructed in accordance with one embodiment of the presently claimed subject matter;

FIG. 4 is a top planar view of the structural ring shown in FIG. 3 in accordance with one embodiment of the presently claimed subject matter;

FIG. 5 is a cross-sectional view of the structural ring shown in FIG. 3, the cross-sectional cut taken substantially through section 5-5 of FIG. 4;

FIG. 6 is an isometric view of the structural ring being used in conjunction with a conveyor belt system from a kaiten sushi restaurant;

FIG. 7 is a cross-sectional view of a conveyor belt system from a kaiten sushi restaurant employing a structural ring in accordance with one embodiment of the presently claimed subject matter;

FIG. 8 is a cross-sectional view of a conveyor belt system of a kaiten sushi restaurant utilizing an alternate embodiment of the structural ring;

FIG. 9 is a view of a wrappable identifier label; and

FIG. 10 is an isometric view of a structural ring with a wrappable identifier label being inserted therein.

### DETAILED DESCRIPTION

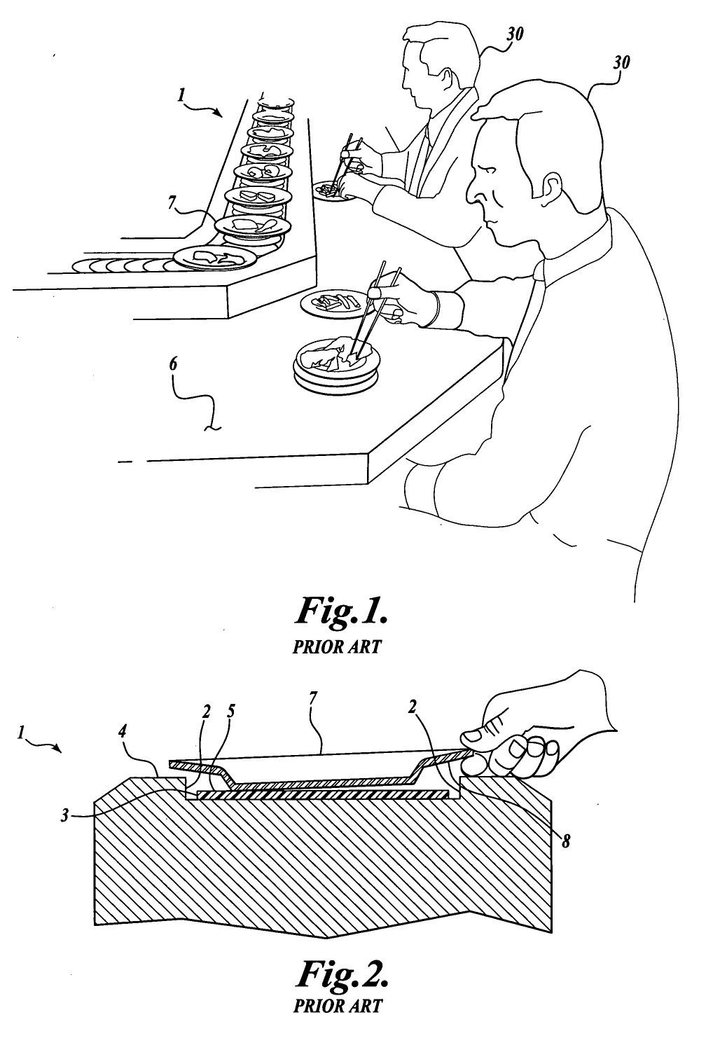

The presently claimed subject matter is described herein with reference to the accompanying illustrations where like numerals correspond to like elements. Suitable embodiments of a structural ring 10 constructed and used in accordance with the presently claimed subject matter, is illustrated in FIGS. 1-10.

FIG. 1 depicts a typical kaiten sushi restaurant. Customers 30 sit at a counter 6 as plates 7 containing various food items pass by on a conveyor belt system 1. When a customer 30 desires a particular food item, the customer 30 removes the plate 7 containing that food item from the conveyor belt system 1. Each plate 7 is typically color coded to represent the price of the item on the plate 7. As the customer 30 finishes various food items, the customer retains the empty color coded plates 7. At the end of the customer's 30 meal, the server counts the plates 7 of each different color that the customer 30 has accumulated. By multiplying the price associated with a given plate color by the number of plates 7 of that color and then adding these amounts, the server calculates the total cost of the food items taken from the conveyor belt system 1 by the customer 30.

Still referring to FIG. 1, the conveyor belt system 1 is positioned relative to the counter 6 so that a customer 30 can easily view the plates 7 containing food items as they passes by on the conveyor belt system 1. The conveyor belt system 1 is also positioned so that a customer 30 can easily reach the conveyor belt system 1 to remove a plate 7 containing a desired food item when the plate 7 passes by. Although a counter 6 is shown in FIG. 1, other seating arrangements are possible. For example, customers 30 may be seated in a booth with the conveyor belt system 1 located so that it is accessible by a customer 30 sitting at one end of the booth. Any seating arrangement is possible, as long as food items are visible to all members of a dining party and at least one customer 30 in a party can reach the conveyor belt system 1.

FIG. 2 depicts a cross-sectional view of a typical conveyor belt system 1 in a kaiten sushi restaurant. The conveyor belt system 1 has an endless movable belt 3 for transporting food items. Plates 7 containing food items are placed on the movable belt 3 and are transported around the restaurant by the conveyor belt system 1 as the movable belt 3 completes a circuit around the restaurant. The movable belt 3 has a top surface 5 upon which the plates 7 are placed. The movable belt 3 itself, is recessed below the top surface 4 of the conveyor belt system 1. Lateral guides 2 generally extend between the top surface 4 of the conveyor belt system 1 and the recessed movable belt 3. The lateral guides 2 help prevent the plates 7 from sliding off of the movable belt 3 as the plates 7 travel around the conveyor belt system 1.

A customer 30 wishing to remove a plate 7 containing a particular food item from the conveyor belt system 1 moves a hand 31 toward the conveyor belt system 1 and extends one or more fingers under the bottom surface 8 of the plate 7. The customer 30 is thereby able to grasp the plate 7 by its edge and lift the plate 7 off of the conveyor belt system 1. However, a typical sushi plate 7 is of limited height. Consequently, when the plate 7 rests on the movable belt 3, the bottom surface of the plate 8 is in close proximity to the top surface 4 of the conveyor belt system 1, making it difficult for a customer 30 to extend any fingers underneath the plate. This hampers the customer's 30 ability to grasp and remove the plate 7 from the conveyor belt system 1.

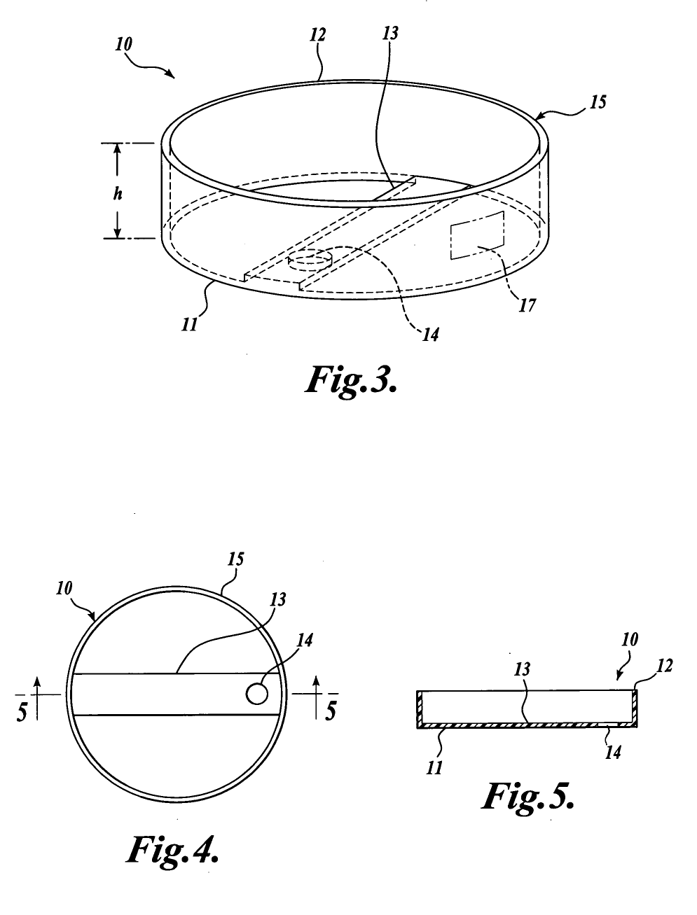

Referring now to FIGS. 3-5, one embodiment of the structural ring 10 will now be described. As shown in FIG. 3, the structural ring 10 generally has an extruded cross-section 15 having a first end 11 and a second end 12. The distance between the first end 11 and the second end 12 is a height h. The cross-section 15 of the structural ring 10 is sized to fit between the two lateral guides 2 when the structural ring 10 is placed on the movable belt 3 of the conveyor belt system 1. Further, the cross-section 15 is shaped so that the second end 12 of the structural ring 10 can support a sushi plate 7 placed on the structural ring 10. The height h of the structural ring 10 is such that when a plate 7 is placed on the second end 12 of the structural ring 10, the bottom surface 8 of the plate 7 is a sufficient distance from the top surface 4 of the conveyor belt system 1 so that a customer 30 can easily grasp the edge of the plate 7 in order to remove the plate 7 from the conveyor belt system 1. Although the cross-section 15 shown in FIG. 3 is generally circular, it can easily be appreciated that the cross-section 15 can be any shape to enable the second end 12 of the structural ring 10 to support a plate 7. Other possible shapes include a square, a rectangle, an ellipse, a closed curve, and an arcuate shape capable of supporting a plate. It can further be appreciated that the cross-section need not be constant from the first end 11 to the second end 12, but can vary in both size and shape between the first end 11 and the second end 12.

Referring to FIGS. 4 and 5, a cross-member 13 having a generally rectangular shape diametrically spans the opening of the first end 11. In one embodiment, the substantially flat cross-member 13 is fixedly attached to the structural ring 10 at opposite sides of the cross-section 15 at the first end 11 of the structural ring 10. Disposed within the cross-member 13 is a hole 14 with an axis in the general direction of the height h of the structural ring 10. The hole 14 is sized so that it can rotationally engage one of a plurality of pins 16 that are fixedly attached to the movable belt 3. When the structural ring 10 is placed on the movable belt 3, the hole 14 engages the pin 16, thereby operably fixing the structural ring 10 to the movable belt 3. This rotational engagement helps prevent the structural ring 10 from slipping off of the movable belt 3, and also helps to maintain the structural ring 10 in a generally constant orientation relative to the movable belt 3.

Although the cross-member 13 is shown having a rectangular shape and spanning the opening of the first end 11, it can easily be appreciated that the cross-member 13 can have any shape suitable for attaching to the first end 11 of the structural ring 10 and providing a hole 14 for engaging a pin 16. Another possible embodiment of the cross-member 13 is an “end cap” that completely closes the opening of the first end 11 of the structural ring 10. Still another possible embodiment of the cross-member 13 is a protrusion on the interior wall of the structural ring 10 in which a hole 14 is located such that the hole 14 operably engages the pin 16 on the movable belt 3.

The structural ring 10 can be made from almost any material suitable to support the weight of a plate 7 and the food items placed thereon. Among the possible materials are polymeric materials, wood, glass, and metal. The structural ring 10 can be opaque or translucent.

One or more identifying marks 17 may be located on the structural ring 10. The identifying mark 17 may contain information for the customer 30 including one or more of the name of the food items, the ingredients of the food items, how the food items are prepared, and the price of the food items. The information on the mark 17 can also indicate to a chef what dish is meant to be placed on a particular structural ring 10. When the chef sees a structural ring 10 without a plate 7, the chef can prepare a suitable replacement food item for placement on the empty structural ring 10. The identifying mark 17 can be fixedly or removably attached to the structural ring 10 in a variety of ways including etching, engraving, silk screening, attaching stickers or labels, or any other suitable means for affixing the identifying mark 17 to the structural ring 10. The identifying mark 17 can comprise text, pictures, symbols, a bar code suitable for scanning by a bar code reader, or any other mark suitable for relaying information.

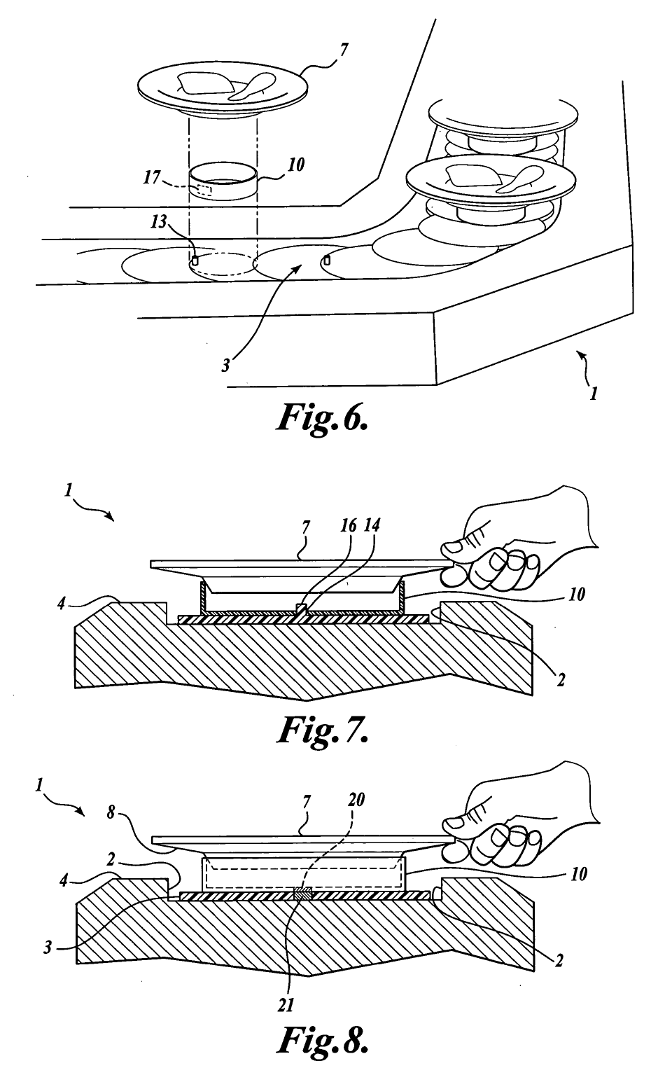

Referring to FIG. 6, use of the structural ring 10 in association with a plate 7 and a conveyor belt system 1 is shown. The structural ring 10 is placed on the movable belt 3 of the conveyor belt system 1 so that the first end 11 of the structural ring 10 rests on the movable belt 3. The hole 14 in the cross-member 13 of the structural ring 10 engages a pin 16 that is fixedly attached to the movable belt 3. A plurality of such pins 16 are fixedly attached to the movable belt 3, spaced to provide clearance between consecutive plates 7 on the movable belt 3. The structural ring 10 fits between the lateral guides 2 of the conveyor belt system 1.

Plates 7 holding various food items are placed on the structural ring 10 and then transported through the restaurant on the conveyor belt system 1 to be displayed and made accessible to the customers 30. Customers 30 identify the food items on the plates 7 by looking at the food items as well as the identifying marks 17 on the structural rings 10 supporting the plates 7, and make their choices accordingly. Chefs may also use the identifying mark 17 of an empty structural ring 10 to determine what food item was previously on the structural ring 10, thereby enabling the chef to prepare a suitable replacement food item.

FIG. 7 shows a cross-section of a structural ring 10 supporting a plate 7 on the conveyor belt system 1. A pin 16, which is fixedly attached to the movable belt 3, engages the hole 14 in the cross-member 13 of the structural ring 10. The structural ring 10 is thereby secured to the movable belt 3. A plate 7 is disposed on the second end 12 of the structural ring 10. The structural ring 10 maintains the plate 7 in an elevated position to increase the distance between the upper surface 4 of the conveyor belt system 1 and the bottom surface 8 of the plate 7. A customer 30 cans thereby more easily grasp the edge of the plate 7.

FIG. 8 shows an alternate embodiment of the presently-claimed structural ring system. Instead of utilizing a pin 16 and hole 14 as shown in FIG. 7, the embodiment shown if FIG. 8 uses a magnetic attraction between a first magnet 20 and a second magnet 21 to fix the structural ring 10 to the movable belt 3. The first magnet 20 is fixedly attached to the structural ring 10. The first magnet 20 can be affixed to the structural ring 10 in any suitable manner including adhesives, press-fit, mechanical attachment, or any other suitable method. The second magnet 21 is fixedly attached to the movable belt 3. The second magnet 21 has a polarity opposite to the polarity of the first magnet 20 so that the first magnet 20 and the second magnet 21 are magnetically attracted to each other. When the structural ring 10 is placed on the movable belt 3, the first magnet 20 and the second magnet 21 attract each other, thereby securing the structural ring 10 to the movable belt 3. It may be easily appreciated by one of skill in the art that the structural ring 10 may be positionally fixed relative to the movable belt 3 in any suitable manner. Alternate embodiment include a pin attached to the structural ring that engages a hole in the movable belt 3, the cross-section 15 of the structural ring 10 engaging a complementary groove in the movable belt 3, or any other means for positionally fixing the structural ring 10 relative to the movable belt 3.

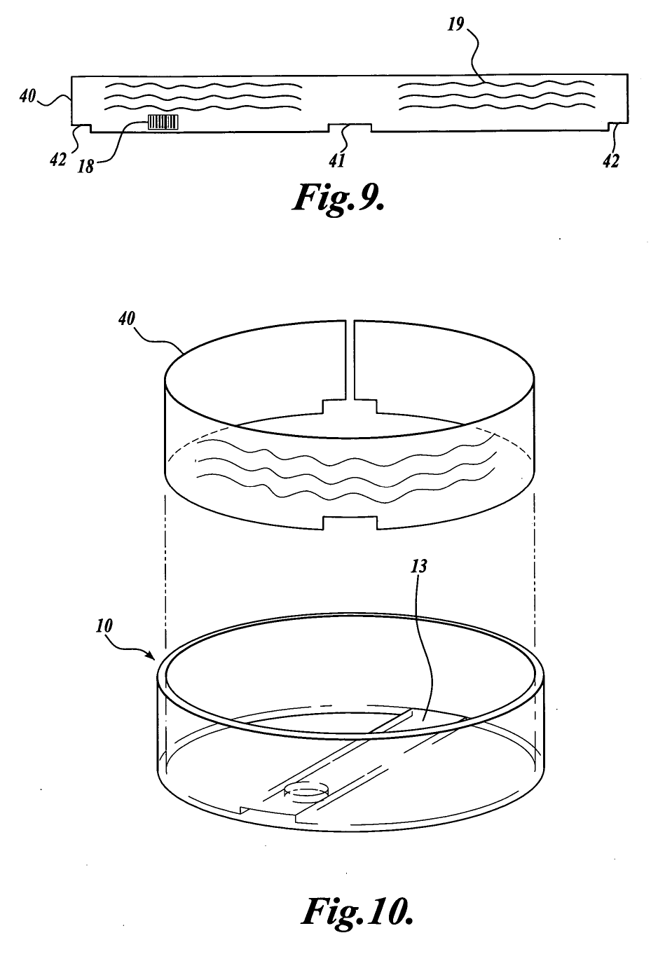

FIG. 9 shows wrappable identifier label 40, suitable for use with a structural ring 10 made from a generally translucent material. As shown in FIG. 10, the wrappable identifier label 40 is designed to wrap around and fit snugly inside the structural ring 10 such that the generally translucent ring 10 protects the label from dirt and foodstuffs. The identifier label 40 may contain information such as the name of the food items on the supported plate 7, whether the food items are raw or cooked, whether the food items are vegetarian or contain meat, the ingredients of the food items, and the Japanese name of the food items. The information about the food items may be printed on both sides of the identifier label 40 so that it can be read by both the customer 30 as the structural ring supporting a plate 7 of food circulates through the restaurant, and also by a chef when an empty structural ring 10 requires a replacement plate 7 of food items.

The identifier label 40 in this particular embodiment is generally rectangular, having a length similar to the inside circumference of the structural ring 10 and a width similar to the height of the structural ring. A first notch 41 having the approximate width of the cross-member 13 of the structural ring 10 and the approximate depth of the height of the cross-member 13 is located along one lengthwise edge of the identifier label 40. The first notch 41 is sized so that when the identifier label 40 is wrapped around the inside of the structural ring 10, the first notch 41 fits over a first end of the cross-member 13 of the structural ring 40. A second and third notch 42 are located on the same lengthwise side as the first notch 41, the second notch located at a first end of the identifier label 40 and the third notch located at a second end of the identifier label 40.

When the label 40 is wrapped around the inside circumference of the structural ring 10, the second and third notches 42 cooperate to form one larger notch, which is generally shaped similar to the first notch 41. The notch formed by the second and third notches 42 is sized and shaped to engage a second end of the cross-member 13 when the identifier label 40 is wrapped around the inside circumference of the structural ring 10 and the first notch 41 is engaging the first end of the cross-member 13.

It may easily be appreciated by one of skill in the art that the size and shape of the identifier label 40 may vary to accommodate various configurations of a structural ring 10. In addition, information 19 printed on the identifier label 40 may also vary to suit the restaurant owner's and/or needs. The identifier label 40 may further include a bar code 18 located for use with an electronic scanning system that may be used in connection with the conveyor belt system 1 to monitor inventory and sales. The bar code 18 may be located on the inside or the outside of the label 40. The label 40 may be made from paper, laminated paper, thin polymeric material, or any other material upon which a bar code 18 and/or information 19 may be printed.

While illustrative embodiments have been shown and described, it will be appreciated that various changes can be made therein without departing from the spirit and scope of the invention.

The embodiments of the invention in which an exclusive property or privilege is claimed are defined as follows:

1. A structural ring for use with a plate on a conveyor belt system, the conveyor belt system having a movable belt portion operably disposed between two lateral guide surfaces, said structural ring having a generally open first end opposite a generally open second end, said ring being sized to be disposed between the lateral guide surfaces of the conveyor belt system when the first end of the structural ring is positioned on the movable belt portion of the conveyor belt system, the first end of the structural ring having a cross-member that at least partially occupies the opening of the first end, the second end of the structural ring being sized to support a plate positioned on the second end so that when the first end of the structural ring is resting on the movable belt portion of the conveyor belt, the bottom surface of the plate positioned on the second end of the structural ring is located above the lateral guide surfaces of the conveyor belt system, wherein the cross-member operably couples the structural ring to the movable belt.

2. The structural ring according to claim 1 wherein a hole is located in the cross-member to operatively engage a pin, said pin being fixedly associated with the movable belt portion of the conveyor belt system.

3. The structural ring according to claim 1 wherein a first magnet is fixedly associated with the cross-member to magnetically engage a second magnet, said second magnet being fixedly associated with the movable belt portion of the conveyor belt system.

4. The structural ring according to claim 1 wherein at least one identifier mark is located on the structural ring.

5. The structural ring according to claim 4 wherein the at least one identifier mark located on the structural ring includes one or more of the name of a food item on a plate supported by the ring, the ingredients of the food item, a price, and a bar code.

6. The structural ring according to claim 1 wherein the cross-section of the ring is generally shaped to be one of a circle, a square, a rectangle, an ellipse, a closed curve, and any arcuate shape capable of supporting a plate.

7. A food delivery system comprising:
(a) a plurality of plates on which servings of food may be disposed;
(b) a conveyor belt system for moving the plurality of plates between a first location where food items are prepared and a second location where a person can remove one or more of the plurality of plates from the conveyor belt system, the conveyor belt system having a movable belt portion operably disposed between two lateral guides so that the movable belt portion is generally lower than a top of the lateral guides;
(c) a plurality of structural rings, each structural ring having a first end with an opening, a second end with an opening, and a cross-section suitable for supporting a plate, wherein the first end has a cross-member that at least partially occupies the opening of the first end and operably couples the structural ring to the movable belt portion of the conveyor belt system, wherein the second end is located above the first end to support a plate so that a bottom surface of the plate is positioned above the lateral guides, and wherein the cross-section is sized for the ring to be disposed between the two lateral guides of the conveyer belt system.

8. The food delivery system according to claim 7 wherein the cross-member has a hole to operatively engage a pin, said pin being fixedly associated with the movable belt portion of the conveyor belt system.

9. The food delivery system according to claim 7 wherein a first magnet is fixedly associated with the cross-member to magnetically engage a second magnet, said second magnet being fixedly associated with the movable belt portion of the conveyor belt system.

10. The food delivery system according to claim 7 having one or more identifying marks located on the structural ring.

11. The food delivery system according to claim 10 wherein the one or more identifying marks located on the structural ring includes at least one of the name of a food item, the ingredients of a food item, the price of a food item, and a bar code.

12. A method for delivering food comprising:
(a) providing a structural ring on a movable belt portion of a conveyer belt system, said conveyor belt system operatively transporting a plate containing a food item between a first location where said food item is prepared and a second location where a person can remove said plate from the conveyor belt system, said conveyor belt system having a top surface located above and proximate to the movable belt portion of the conveyor belt system;
(b) placing a food item on a plate;
(c) placing the plate on the structural ring at the first location so that a bottom surface of the plate is above the top surface of the conveyor belt system; and
(d) transporting the plate on the structural ring to the second location.

13. The method for delivering food according to claim 12 wherein providing a structural ring on a movable belt portion of a conveyer belt system further includes positioning the structural ring on the movable belt portion of the conveyer belt system such that a pin operably fixes the structural ring to the movable belt.

14. The method for delivering food according to claim 12 wherein providing a structural ring on a movable belt portion of a conveyer belt system further includes positioning the structural ring on the movable belt portion of the conveyer belt system such that a magnet operably fixes the structural ring to the movable belt.

15. The method for delivering food according to claim 12 wherein providing a structural ring on a movable belt portion of a conveyer belt system further includes preparing an identifier label and placing the identifier label within the structural ring.

16. The method for delivering food according to claim 12 wherein providing a structural ring on a movable belt portion of a conveyer belt system further includes preparing an identifier label and placing the identifier label within the structural ring so that at least one notch defined in the identifier label operably engages a cross member of the structural ring.
